(19) United States
(12) Patent Application Publication
(10) Pub. No.: US 2022/0322307 A1
(43) Pub. Date: Oct. 6, 2022

(54) MODULATION CODING SCHEME TABLE EXTENSION FOR NARROWBAND INTERNET OF THINGS USER EQUIPMENT

(71) Applicant: NOKIA TECHNOLOGIES OY, Espoo (FI)

(72) Inventors: Rapeepat RATASUK, Inverness, IL (US); Nitin MANGALVEDHE, Hoffman Estates, IL (US)

(21) Appl. No.: 17/218,629

(22) Filed: Mar. 31, 2021

(51) Int. Cl. H04W 72/04; H04L 5/00

(52) U.S. Cl. CPC H04W 72/042; H04L 5/0044; H04L 27/18

(57) ABSTRACT

Systems, methods, apparatuses, and computer program products for modulation coding scheme (MCS) table extension for narrowband Internet of Things (NB-IoT). The method may include receiving at a user equipment, downlink control information from a network node comprising a modulation and coding scheme field and a repetition number field. The method may also include reading the modulation and coding scheme field and the repetition number field. The method may further include determining a modulation and coding scheme value and a repetition number based on an indication in the modulation and coding scheme field. In addition, the method may include setting a transmission block size index value based on the determination.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain example embodiments may relate to apparatuses, systems, and/or methods for modulation coding scheme (MCS) table extension for narrowband Internet of Things (NB-IoT) configured with 16-quadrature amplitude modulation (16-QAM).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on NR technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) are named gNB when built on NR technology and named NG-eNB when built on E-UTRAN radio.

### SUMMARY

Some example embodiments may be directed to a method. The method may include receiving at a user equipment, downlink control information from a network node including a modulation and coding scheme field and a repetition number field. The method may also include reading the modulation and coding scheme field and the repetition number field. The method may further include determining a modulation and coding scheme value and a repetition number based on an indication in the modulation and coding scheme field. In addition, the method may include setting a transmission block size index value based on the determination.

Other example embodiments may be directed to an apparatus. The apparatus may include at least one processor and at least one memory including computer program code. The at least one memory and computer program code may be configured to, with the at least one processor, cause the apparatus at least to receive downlink control information from a network node including a modulation and coding scheme field and a repetition number field. The apparatus may also be configured to read the modulation and coding scheme field and the repetition number field. The apparatus may further be configured to determine a modulation and coding scheme value and a repetition number based on an indication in the modulation and coding scheme field. In addition, the apparatus may be configured to set a transmission block size index value based on the determination.

Other example embodiments may be directed to an apparatus. The apparatus may include means for receiving downlink control information from a network node including a modulation and coding scheme field and a repetition number field. The apparatus may also include means for reading the modulation and coding scheme field and the repetition number field. The apparatus may further include means for determining a modulation and coding scheme value and a repetition number based on an indication in the modulation and coding scheme field. In addition, the apparatus may include means for setting a transmission block size index value based on the determination.

In accordance with other example embodiments, a non-transitory computer readable medium may be encoded with instructions that may, when executed in hardware, perform a method. The method may include receiving at a user equipment, downlink control information from a network node including a modulation and coding scheme field and a repetition number field. The method may also include reading the modulation and coding scheme field and the repetition number field. The method may further include determining a modulation and coding scheme value and a repetition number based on an indication in the modulation and coding scheme field. In addition, the method may include setting a transmission block size index value based on the determination.

Other example embodiments may be directed to a computer program product that performs a method. The method may include receiving at a user equipment, downlink control information from a network node including a modulation and coding scheme field and a repetition number field. The method may also include reading the modulation and coding scheme field and the repetition number field. The method may further include determining a modulation and coding scheme value and a repetition number based on an indication in the modulation and coding scheme field. In addition, the method may include setting a transmission block size index value based on the determination.

Other example embodiments may be directed to an apparatus that may include circuitry configured to receive downlink control information from a network node comprising a modulation and coding scheme field and a repetition number field. The apparatus may also include circuitry configured to read the modulation and coding scheme field and the repetition number field. The apparatus may further include circuitry configured to determine a modulation and coding scheme value and a repetition number based on an indication in the modulation and coding scheme field. In addition, the apparatus may include circuitry configured to set a transmission block size index value based on the determination.

Certain example embodiments may be directed to a method. The method may include transmitting, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

Other example embodiments may be directed to an apparatus. The apparatus may include at least one processor and at least one memory including computer program code. The at least one memory and computer program code may be configured to, with the at least one processor, cause the apparatus at least to transmit, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

Other example embodiments may be directed to an apparatus. The apparatus may include means for transmitting, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

In accordance with other example embodiments, a non-transitory computer readable medium may be encoded with instructions that may, when executed in hardware, perform a method. The method may include transmitting, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

Other example embodiments may be directed to a computer program product that performs a method. The method may include transmitting, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

Other example embodiments may be directed to an apparatus that may include circuitry configured to transmit, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

### BRIEF DESCRIPTION OF THE DRAWINGS

For proper understanding of example embodiments, reference should be made to the accompanying drawings, wherein:

FIG. 1 illustrates an example downlink (DL) transport block size (TBS) table for a user equipment configured with 16-QAM.

FIG. 2 illustrates an example uplink (UL) TBS table for a UE configured with 16-QAM.

FIG. 3 illustrates an example modulation coding scheme (MCS) table extension for downlink control information (DCI) Format NO, according to certain example embodiments.

FIG. 4 illustrates an example MCS table extension for DCI Format N1, according to certain example embodiments.

FIG. 5 illustrates an example procedure for determining the MCS value and the repetition number based on an indication in the MCS field, according to certain example embodiments.

FIG. 6 illustrates an example flow diagram of a method, according to certain example embodiments.

FIG. 7 illustrates an example flow diagram of another method, according to certain example embodiments.

FIG. 8(a) illustrates an apparatus, according to certain example embodiments.

FIG. 8(b) illustrates another apparatus, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for modulation coding scheme (MCS) table extension for narrowband Internet of Things (NB-IOT) configured with 16-quadrature amplitude modulation (16-QAM).

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

3^{rd} Generation Partnership Project (3GPP) provides support for IoT enhancements, and objectives to specify 16-QAM support for NB-IoT. For instance, 16-QAM is specified for unicast in uplink (UL) and downlink (DL), including necessary changes to DL power allocation for narrow band physical downlink shared channel (NPDSCH) and DL transport block size (TBS). This is specified without a new NB-IoT user equipment (UE) category. For DL, an increase in maximum TBS of, for example, 2× the Rel-16 maximum, and soft buffer size may be specified by modifying at least existing Category NB2. For UL, the maximum TBS may not be increased. 3GPP also describes extension of the NB-IoT channel quality reporting based on the framework of Rel-14-16 to support 16-QAM in DL.

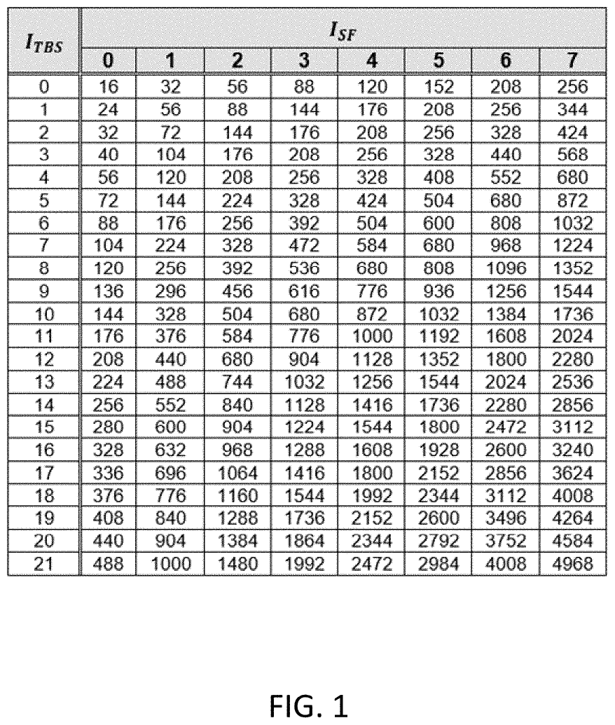

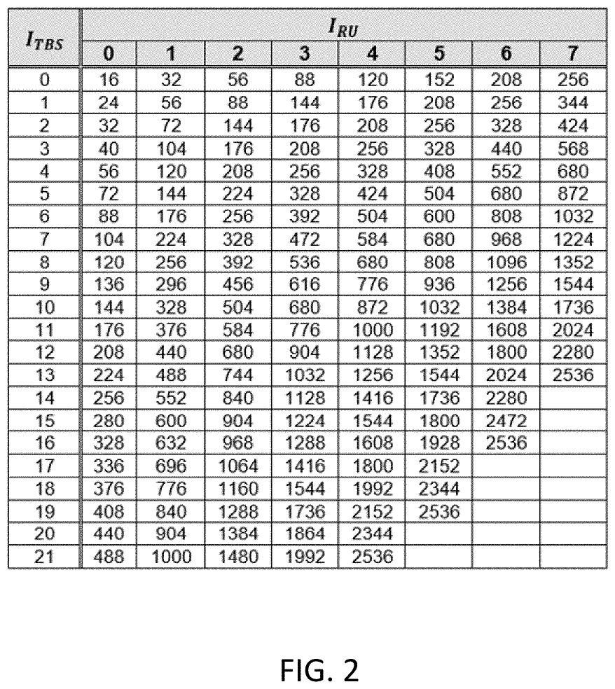

FIG. 1 illustrates an example DL TBS table for a UE configured with 16-QAM, and FIG. 2 illustrates an example UL TBS table for a UE configured with 16-QAM. RANI introduced new MCS values for 16-QAM as shown in the tables of FIGS. 1 and 2. In addition, RANI agreed that repetition is not supported when the UE is scheduled using 16-QAM modulation (i.e., when the UE is scheduled with MCS between 14-21).

Although 16-QAM may be used for the UE in good channel condition, the downlink control information (DCI) may support being able to schedule all of the existing quadrature phase shift keying (QPSK) MCS values and reception values when the UE is configured with 16-QAM. This avoids having to perform costly radio resource control (RRC) reconfiguration as the radio condition at the UE changes. As a result, it may be possible for the eNB to configure UEs supporting 16-QAM capability with 16-QAM even if the current radio condition does not support the use of 16-QAM modulation. One way to accomplish this may be to increase the size of the “Modulation and coding scheme” field in DCI N0/N1 by 1 bit (e.g., from 4 to 5 bits) to accommodate the additional 16-QAM entries in the MCS tables. However, this increases the DCI size, and may not be preferred due to reduced performance of the narrowband physical downlink control channel (NPDCCH) used to transmit the DCI. In addition, the UE may monitor two different DCI sizes—the old DCI size in common search space and the new DCI size in UE specific search space.

Alternatively, the DCI fields “Modulation and coding scheme” and “Repetition number” may be jointly coded together to support new 16-QAM entries. In this case, there may be no increase in DCI size. However, the DCI interpretation (i.e., encoding and decoding) may become complicated as the two fields must now be combined together and all supported combinations would then need to be defined (e.g., using a new table). Thus, there is a need for a simple MCS extension method when the UE is configured with 16-QAM that does not increase DCI size.

Alternately, the DCI fields “DCI subframe repetition number” and “Repetition number” may be used to indicate a new or extended MCS table. If the field “DCI subframe repetition number” indicates there is no repetition used for the NPDCCH, one or more bits in the “Repetition number” field can be used to denote the MCS table. For example, the most significant bit in the “Repetition number” together with 4 bits from the existing “Modulation and coding scheme” field can be used to indicate 5-bit MCS table. This method, however, disallows the use of NPDCCH repetition when a UE is scheduled with 16-QAM modulation.

Certain example embodiments may provide a method for interpreting the “Modulation and coding scheme” field and the “Repetition number” field in the DCI based on indication in the “Modulation and coding scheme” field when the NB-IoT UE is configured with 16-QAM. Certain example embodiments may take advantage of when the repetition number is 1 (i.e., no repetition) when the UE is scheduled with 16-QAM. Thus, in certain example embodiments, indication of the repetition number in DCI may not be necessary.

According to certain example embodiments, the MCS table may be extended by using the “Repetition number” field in DCI. According to other example embodiments, an unused state in the MCS table may indicate to the UE to use the extended MCS table. For instance, for a UE configured with 16-QAM, if the “Modulation and coding scheme” field indicates a value between 0-13, the UE may use the MCS value (I_MCS) as indicated by the “Modulation and coding scheme” field in DCI and repetition number value (I_Rep) as indicated by the “Repetition number” field in DCI. Otherwise, the UE may be scheduled with 16-QAM, the number of repetition may be set to 1 (i.e., no repetition), and the UE may determine the 16-QAM MCS value as indicated by the “Repetition number” field in DCI using a predefined MCS table extension. In certain example embodiments, a specific MCS value greater than 13 (e.g., “1110” in binary or 14) may be defined for this purpose. In other words, an unused MCS state may indicate an extension to the MCS table. According to certain example embodiments, this method can be applied for UE configured with quadrature modulation scheme in general, and not just for 16-QAM (e.g. 64-QAM, 256-QAM, etc.), or for UE configured with another modulation scheme (e.g. phase-shift keying).

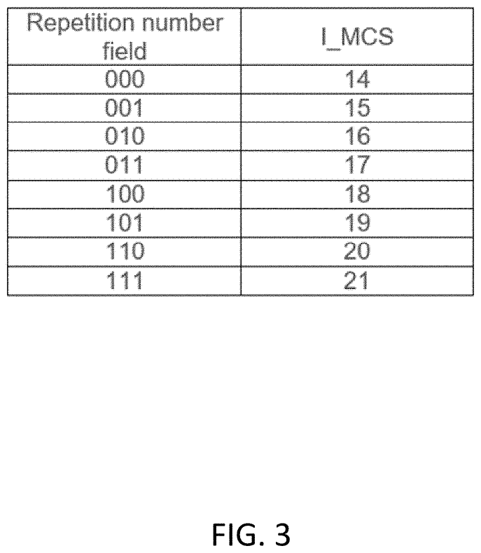

FIG. 3 illustrates an example MCS table extension for DCI Format NO, according to certain example embodiments. In particular, FIG. 3 illustrates a table of MCS indication when the MCS is set to “1110”. According to certain example embodiments, for DCI NO, the “Repetition number” field size may be 3 bits.

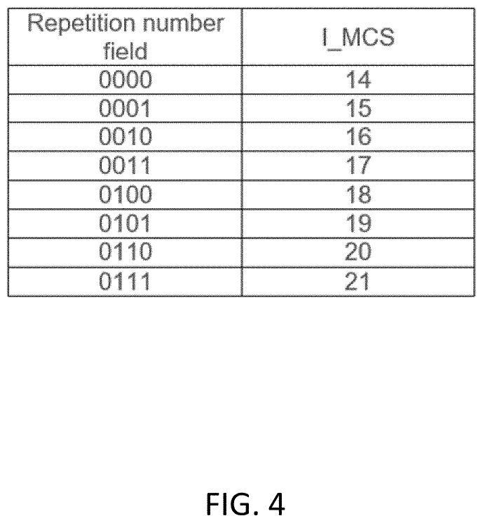

FIG. 4 illustrates an example MCS table extension for DCI Format N1, according to certain example embodiments. In particular, FIG. 4 illustrates a table of MCS indication when the MCS is set to “1110”. According to certain example embodiments, for DCI N1, the “Repetition number” field size may be 4 bits. Alternatively, according to other example embodiments, for DCI N1, only the last 3 least significant bits (LSBs) may be used to indicate the I_MCS with the most significant bit (MSB) reserved or used for another purpose.

In certain example embodiments, the UE may be configured for 16-QAM via RRC configuration or medium access control (MAC) control element (CE) signaling. Alternatively, the UE may be implicitly configured with 16-QAM if the network indicates 16-QAM support via system information block(s) (SIB). In some example embodiments, the network may use legacy MCS and repetition values for the UE until the UE is in RRC CONNECTED state, and UE capability is known at the network. In other example embodiments, the UE may not assume implicit configuration of 16-QAM for DL until it provides extended channel quality information for 16-QAM.

According to certain example embodiments, instead of using MCS extension, the UE may be configured with two tables—one for QPSK and one for 16-QAM. For example, in certain example embodiments, the MCS table to use may be indicated via an unused or predefined state in one of the DCI fields. Alternatively, in other example embodiments, the MCS table to use may be implicitly determined based on the indication via the “Modulation and coding scheme field”.

In certain example embodiments, in DCI Format N1 (DL scheduling grant), the Repetition number field may include 4 bits where only 3 bits may be needed for I-MCS indication. The extra bit (e.g., MSB) may be used for requesting channel quality report (e.g., Repetition number field=“1000” means I_MCS=14 and UE is requested to send a channel quality report). With this method, there is no change in how the UE would interpret the DCI when the “Modulation and coding scheme” field indicates a value between 0-13. As such, this may be fully backward compatible with pre-Rel-17 UE implementation.

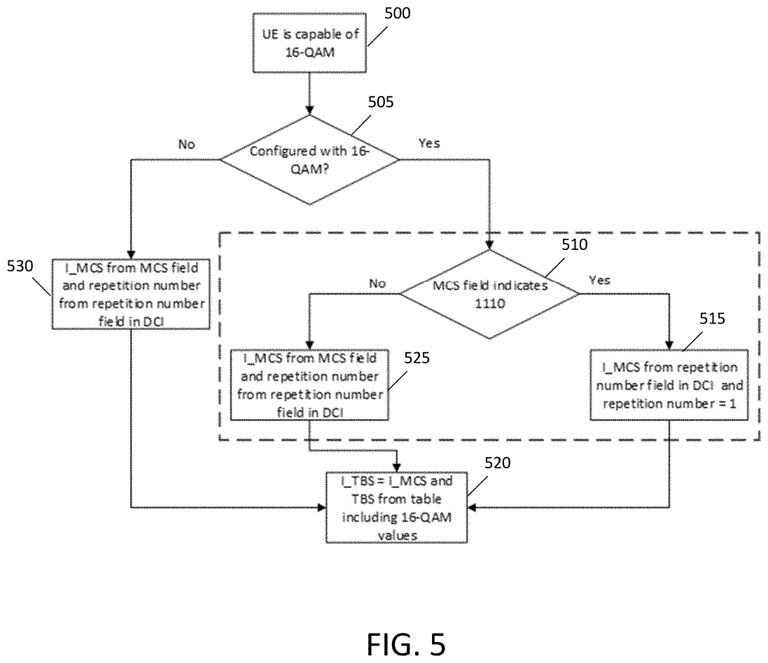

FIG. 5 illustrates an example procedure for determining the MCS value and the repetition number based on an indication in the MCS field, according to certain example embodiments. As illustrated in FIG. 5 and described herein, the UE may read the “Modulation and coding scheme” field and the “Repetition number” field, and interpret them as described above to obtain the MCS value I_MCS. The UE may then set a TBX index I_TBS=I_MCS, and determine the TBS using the tables with 16-QAM values. As illustrated in FIG. 5, at 500, the UE may check if it is capable of 16-QAM. At 505, a determination may be made as to whether the UE is configured with 16-QAM. If yes, at 510, the UE may determine whether the “Modulation and coding scheme” field includes a “1110” indication. If so, the MCS value may be designated as being greater than 13, and the “1110” indication can serve as an identification of an unused MCS state indicating an extension to the MCS table. At 515, the UE may determine the I_MCS value from the “Repetition number” field in the DCI, and the repetition number may be set to 1. At 520, the UE may set the I_TBS value equal to the I_MCS value, and determine the TBS from using the tables with 16-QAM values.

If, it is determined at 510 that the MCS field does not indicate “1110”, at 525, the UE may determine the I_MCS value from the “Modulation and coding scheme” field in the DCI, and the repetition number from the “Repetition number” field in the DCI. Additionally, if it is determined that the UE is not configured with 16-QAM, at 530, the UE may determine the I_MCS value from the “Modulation and coding scheme” field in the DCI, and determine the repetition number from the “Repetition number” field in the DCI.

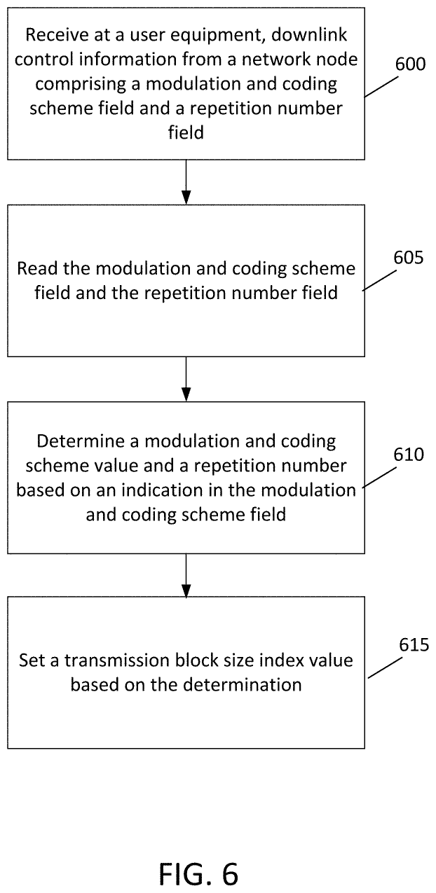

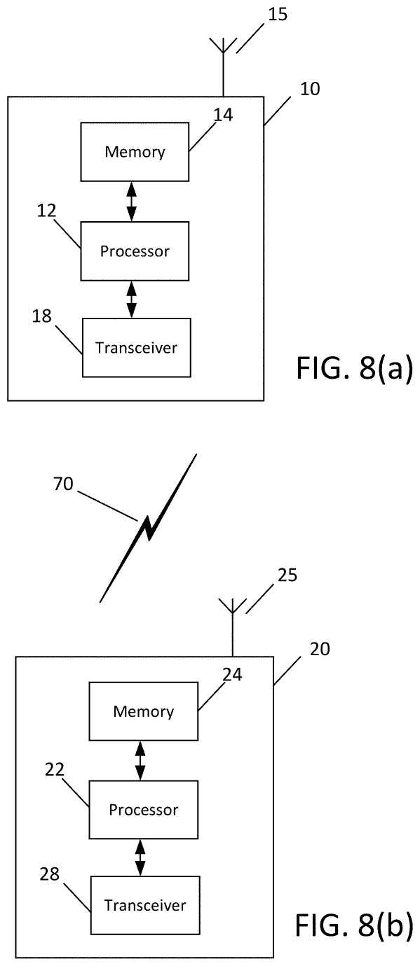

FIG. 6 illustrates an example flow diagram of a method, according to certain example embodiments. In an example embodiment, the method of FIG. 6 may be performed by a network entity, network node, or a group of multiple network elements in a 3GPP system, such as LTE or 5G-NR. For instance, in an example embodiment, the method of FIG. 6 may be performed by a UE, for instance similar to apparatus 10 illustrated in FIG. 8(a).

According to certain example embodiments, the method of FIG. 6 may include, at 600, receiving at a user equipment, downlink control information from a network node comprising a modulation and coding scheme field and a repetition number field. At 605, the method may include reading the modulation and coding scheme field and the repetition number field. At 610, the method may include determining a modulation and coding scheme value and a repetition number based on an indication in the modulation and coding scheme field. At 615, the method may include setting a transmission block size index value based on the determination.

According to certain example embodiments, the user equipment may be configured with quadrature modulation scheme capability. According to other example embodiments, the transmission block size index value may equal the modulation and coding scheme value. According to further example embodiments, the transmission block size index value may be determined using a table with quadrature modulation scheme values.

In certain example embodiments, when the modulation and coding scheme value is greater than a predefined value, the modulation and coding scheme value may be determined from the repetition number field in the downlink control information, and the repetition number may be set to a value of one. In some example embodiments, when the modulation and coding scheme value is less than the predefined value, the modulation and coding scheme value may be determined from the modulation and coding scheme field in the downlink control information, and the repetition number may be determined from the repetition number field in the downlink control information. In further example embodiments, when the modulation and coding scheme value is a fixed value, the modulation and coding scheme value may be determined from the repetition number field in the downlink control information, and the repetition number is set to a value of one. In other example embodiments, the user equipment may be configured with two tables, one table for quadrature phase shift keying, and another table for a quadrature modulation scheme. In certain example embodiments, the user equipment may be implicitly configured with quadrature modulation scheme capability.

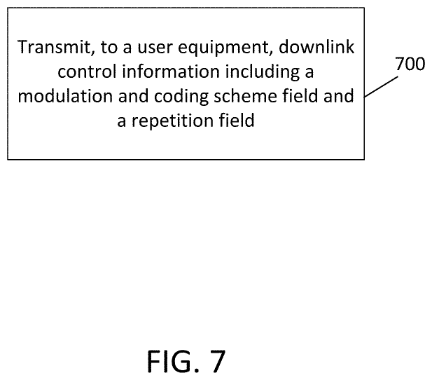

FIG. 7 illustrates an example flow diagram of another method, according to certain example embodiments. In an example embodiment, the method of FIG. 7 may be performed by a network entity, network node, or a group of multiple network elements in a 3GPP system, such as LTE or 5G-NR. For instance, in an example embodiment, the method of FIG. 7 may be performed by a gNB, for instance similar to apparatus 20 illustrated in FIG. 8(b).

According to certain example embodiments, the method of FIG. 7 may include, at 700, transmitting, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

In certain example embodiments, the specific value may be greater than a predefined value. In some example embodiments, the specific value may be equal to a predefined value. In other example embodiments, the specific value may be fixed to a predefined value. According to certain example embodiments, the quadrature modulation scheme capability may be a quadrature modulation scheme capability. According to other example embodiments, the method may also include configuring the user equipment with two tables, one table for quadrature phase shift keying, and another table for a quadrature modulation scheme.

FIG. 8(a) illustrates an apparatus 10 according to certain example embodiments. In certain example embodiments, apparatus 10 may be a node or element in a communications network or associated with such a network, such as a UE, mobile equipment (ME), mobile station, mobile device, stationary device, or other device. It should be noted that one of ordinary skill in the art would understand that apparatus 10 may include components or features not shown in FIG. 8(a).

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 8(a).

As illustrated in the example of FIG. 8(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 8(a), multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-6.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-6.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive downlink control information from a network node comprising a modulation and coding scheme field and a repetition number field. Apparatus 10 may also be controlled by memory 14 and processor 12 to read the modulation and coding scheme field and the repetition number field. Apparatus 10 may further be controlled by memory 14 and processor 12 to determine a modulation and coding scheme value and a repetition number based on an indication in the modulation and coding scheme field. In addition, apparatus 10 may be controlled by memory 14 and processor 12 to set a transmission block size index value based on the determination.

FIG. 8(b) illustrates an apparatus 20 according to certain example embodiments. In certain example embodiments, the apparatus 20 may be a node or element in a communications network or associated with such a network, such as a base station, a Node B, an evolved Node B (eNB), 5G Node B or access point, next generation Node B (NG-NB or gNB), NM, and/or WLAN access point, associated with a radio access network (RAN), such as an LTE network, 5G or NR. It should be noted that one of ordinary skill in the art would understand that apparatus 20 may include components or features not shown in FIG. 8(b).

As illustrated in the example of FIG. 8(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 8(b), multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-5 and 7.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-5 and 7.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

In other example embodiments, apparatus 20 may be controlled by memory 24 and processor 22 to transmit, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations

Certain example embodiments may be directed to an apparatus that includes means for performing any of the methods described herein including, for example, means for receiving downlink control information from a network node comprising a modulation and coding scheme field and a repetition number field. The apparatus may also include means for reading the modulation and coding scheme field and the repetition number field. The apparatus may further include means for determining a modulation and coding scheme value and a repetition number based on an indication in the modulation and coding scheme field. In addition, the apparatus may include means for setting a transmission block size index value based on the determination.

Other example embodiments may be directed to an apparatus that includes means for transmitting, to a user equipment, downlink control information comprising a modulation and coding scheme field and a repetition field. According to certain example embodiments, the modulation and coding scheme field may include a specific value. According to other example embodiments, the repetition field may include a modulation and coding scheme value. According to further example embodiments, the specific value may configure or enable the user equipment to be configured with quadrature modulation scheme capability.

Certain example embodiments described herein provide several technical improvements, enhancements, and/or advantages. In some example embodiments, it may be possible to, without increasing DCI size, enable support for legacy MCS values and repetition numbers for QPSK and new MCS values for 16-QAM (without repetition). According to other example embodiments, it may be possible to allow a simple extension of MCS table without requiring joint coding for multiple fields. In particular, joint coding may involve more complicated encoding and decoding methods, and, thus, increases the complexity both at the network and UE.

Other example embodiments may allow an extension of the MCS table without requiring other restrictions in the DCI scheduling format. For example, certain conventional solutions may require the “DCI subframe repetition number” field to be set to 1 (i.e., no repetition), which would be unnecessarily restrictive.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project

5G 5th Generation

5GCN 5G Core Network

BS Base Station

CE Coverage Enhanced

DCI Downlink Control Information

DL Downlink

eNB Enhanced Node B

gNB 5G or Next Generation NodeB

LSB Least Significant Bit

LTE Long Term Evolution

MSB Most Significant Bit

MTC Machine Type Communication

NB-IoT Narrowband Internet of Things

NPDCCH Narrowband PDCCH

NPDSCH Narrowband PDSCH

NR New Radio

PDCCH Physical Downlink Control Channel

PDSCH Physical Downlink Shared Channel

PRB Physical Resource Block

RRC Radio Resource Control

UE User Equipment

UL Uplink

We claim:

1. A method, comprising:
receiving at a user equipment, downlink control information from a network node comprising a modulation and coding scheme field and a repetition number field;
reading the modulation and coding scheme field and the repetition number field;
determining a modulation and coding scheme value and a repetition number based on an indication in the modulation and coding scheme field; and
setting a transmission block size index value based on the determination.

2. The method according to claim 1, wherein the user equipment is configured with quadrature modulation scheme capability.

3. The method according to claim 1, wherein the transmission block size index value equals the modulation and coding scheme value.

4. The method according to claim 1, wherein the transmission block size index value is determined using a table with quadrature modulation scheme values.

5. The method according to claim 1,
wherein when the modulation and coding scheme value is greater than a predefined value, the modulation and coding scheme value is determined from the repetition number field in the downlink control information, and the repetition number is set to a value of one, and
wherein when the modulation and coding scheme value is less than the predefined value, the modulation and coding scheme value is determined from the modulation and coding scheme field in the downlink control information, and the repetition number is determined from the repetition number field in the downlink control information.

6. The method according to claim 1,
wherein when the modulation and coding scheme value is a fixed value, the modulation and coding scheme value is determined from the repetition number field in the downlink control information, and the repetition number is set to a value of one.

7. The method according to claim 1, wherein the user equipment is configured with two tables, one table for quadrature phase shift keying, and another table for a quadrature modulation scheme.

8. The method according to claim 1, wherein the user equipment is implicitly configured with quadrature modulation scheme capability.

9. An apparatus, comprising:
at least one processor; and
at least one memory comprising computer program code,
the at least one memory and the computer program code are configured, with the at least one processor, to cause the apparatus at least to
receive downlink control information from a network node comprising a modulation and coding scheme field and a repetition number field;
read the modulation and coding scheme field and the repetition number field;
determine a modulation and coding scheme value and a repetition number based on an indication in the modulation and coding scheme field; and
set a transmission block size index value based on the determination.

10. The apparatus according to claim 9, wherein the apparatus is configured with 16-quadrature modulation scheme capability.

11. The apparatus according to claim 9, wherein the transmission block size index value equals the modulation and coding scheme value.

12. The apparatus according to claim 9, wherein the transmission block size index value is determined using a table with quadrature modulation scheme values.

13. The apparatus according to claim 9,
wherein when the modulation and coding scheme value is greater than a predefined value, the modulation and coding scheme value is determined from the repetition number field in the downlink control information, and the repetition number is set to a value of one, and
wherein when the modulation and coding scheme value is less than the predefined value, the modulation and coding scheme value is determined from the modulation and coding scheme field in the downlink control information, and the repetition number is determined from the repetition number field in the downlink control information.

14. The apparatus according to claim 9,
wherein when the modulation and coding scheme value is a fixed value, the modulation and coding scheme value is determined from the repetition number field in the downlink control information, and the repetition number is set to a value of one.

15. The apparatus according to claim 9, wherein the apparatus is configured with two tables, one table for quadrature phase shift keying, and another table for a quadrature modulation scheme.

16. The apparatus according to claim 9, wherein the apparatus is implicitly configured with quadrature modulation scheme capability.

17. A method, comprising:
transmitting, to a user equipment, downlink control information comprising a modulation and coding scheme field and a repetition field,
wherein the modulation and coding scheme field comprises a specific value,
wherein the repetition field comprises a modulation and coding scheme value, and
wherein the specific value configures or enables the user equipment to be configured with quadrature modulation scheme capability.

18. The method according to claim 17,
wherein the specific value is any value greater than a predefined value,
wherein the specific value is equal to a predefined value, or
wherein the specific value is fixed to a predefined value.

19. The method according to claim 17, wherein the quadrature modulation scheme capability is a quadrature modulation scheme capability.

20. The method according to claim 17, further comprising:
configuring the user equipment with two tables, one table for quadrature phase shift keying, and another table for a quadrature modulation scheme.
